(19) United States
(12) Patent Application Publication
(10) Pub. No.: US 2006/0217766 A1
(43) Pub. Date: Sep. 28, 2006

(54) Combination teething device and picture frame

(76) Inventors: Jennifer A. Groover, Springfield, PA (US); Matthew D. Marhefka, Doylestown, PA (US)

Correspondence Address: SYNNESTVEDT & LECHNER, LLP, 2600 ARAMARK TOWER, 1101 MARKET STREET, PHILADELPHIA, PA, 191072950, US

(21) Appl. No.: 11/375,304

(22) Filed: Mar. 14, 2006

Related U.S. Application Data
(60) Provisional application No. 60/661,579, filed on Mar. 14, 2005.

(51) Int. Cl. A61J 17/00

(52) U.S. Cl. 606/235

(57) ABSTRACT

A development-promoting device for infants that combines image-based stimulation with other sensory stimuli. The device includes a teething device usable as a teething ring by an infant. The teething device is capable of housing a photograph, such as a photograph of parents. The teething device is constructed to prevent saliva from deteriorating a photograph held by the teething device when the teething device is being used as a teether. The teething device is mountable to a stand, at which point a picture frame is formed for displaying the teething device's photograph. The stand may include a suction cup to provide tip-resistant mounting of the picture frame to a smooth surface, such as a highchair's tray.

### CROSS-REFERENCE TO RELATED APPLICATION

This application claims the benefit of U.S. Provisional Patent Application No. 60/661,579, filed Mar. 14, 2005, the entire disclosure of which is hereby incorporated herein by reference.

### FIELD OF THE INVENTION

The present invention relates generally to a cognitive and developmental device for infants, wherein the device provides a repetitive visual and tactile stimulus that facilitates infant development.

### DISCUSSION OF THE RELATED ART

It has long been known that infants generally respond well to human faces, in particular to familiar faces. Applicants have discovered that combining one or more of such stimuli with other sensory stimuli, such as touch, creates a positive effect on an infant's cognitive and motor development, and is further promoted with repetitive exposure to such stimuli.

### SUMMARY OF THE INVENTION

The present invention provides a device that combines image-based stimulation, e.g. via a photograph of a human face, with other stimuli, in particular touch and/or taste. Such devices can be used to enhance an infant's cognitive abilities, including sensory/perceptual acuities, discriminations, and response; acquisition of object constancy; memory, learning, and problem solving; vocalization, beginning of verbal communication; basis of abstract thinking; habituation; mental mapping; and the like. In addition, such a device can be used to develop motor skills, including degree of body control, large muscle coordination, finer manipulatory skills of the hands and fingers, dynamic movement, dynamic praxis, postural imitation, and stereognosis.

According to certain preferred embodiments of the present invention, a developmental device is provided in the form of a teething device specially configured as an image frame, e.g. for housing a photographic or holographic image of a familiar person or persons. The teething device has tactile attributes, such as those found in baby teethers. The teething device includes an outer teething ring constructed of a suitable resilient material, such as a firm rubber material, to be used to promote eruption and emergence of teeth from the infants gums.

Optionally, the teething device is specially configured to be selectively repeatedly attachable to and detachable from a stand for supporting the teething device so that the teething device can be used as a picture frame to display a photograph/image in a manner similar to a self-standing table-mounted picture frame.

The image of a familiar face attracts and holds the attention of the infant and will encourage the infant to use the tactile features of the device. Such tactile and visual stimuli facilitates the infant's cognitive and motor development. This embodiment of the device is generally intended for infant development from birth through the first year of his or her life.

### BRIEF DESCRIPTION OF THE DRAWINGS

The present invention will now be described by way of example with reference to the following drawings in which:

FIG. 1 is a top view of an exemplary teething device in accordance with a first embodiment of the present invention;

FIG. 2 is an exploded front perspective view of the teething device of FIG. 1;

FIG. 3 is an exploded rear perspective view of the teething device of FIG. 1;

FIG. 4 is a top view of an exemplary teething device in accordance with a second embodiment of the present invention;

FIG. 5 is a front perspective view of the teething device of FIG. 4;

FIG. 6 is an exploded front perspective view of the teething device of FIG. 4;

FIG. 7 is a rear perspective view of the teething device of FIG. 4;

FIG. 8 is an exploded rear perspective view of the teething device of FIG. 4;

FIG. 9 is a cross-sectional view of the teething device of FIG. 4 taken along line A-A′ of FIG. 7;

FIG. 10 is a front view of a picture frame including the teething device of FIG. 5 mounted on a stand;

FIG. 11 is a front perspective view of the picture frame of FIG. 10;

FIG. 12 is a side perspective view of the picture frame of FIG. 10;

FIG. 13 is a right side view of the picture frame of FIG. 10, the left side view being a mirror image thereof; and

FIG. 14 is a rear perspective view of the picture frame of FIG. 10.

### DETAILED DESCRIPTION

The present invention provides an infant developmental device including a teething device, and optionally an attachable stand to support the teething device as a table-mounted picture frame.

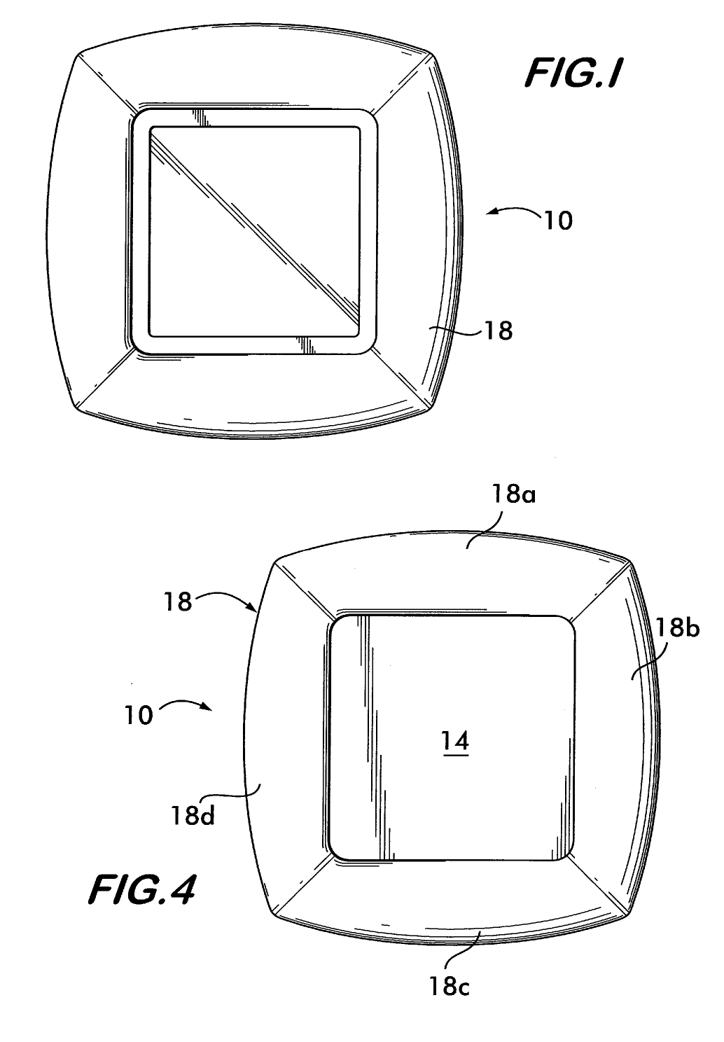

Referring now to the exemplary embodiment of FIGS. 1-3, the teething device 10 is capable of housing an image object, such as a photograph, in an enclosed manner that protects the image object from an infant's saliva when the teething device is used as an infant teether to facilitate eruption and emergence of teeth from the infant's gums by having the infant chew on the teething device.

As shown in FIGS. 1-3, the teething device 10 includes a teething ring 18 configured as a closed loop enclosing a central section. The teething ring is preferably constructed of a semi-firm material, such as rubber, an elastomeric polyethylene or other material of a type generally used for constructing infant teethers (collectively, a “rubbery material”). The teething ring 18 is preferably comprised of visually discrete segments, 18a, 18b, 18c, 18d, each of which is colored a respective one of four different easily distinguishable colors, such as red, blue, green and yellow. These colors provide visual stimulation to an infant user of the teething device 10. Preferably the teething ring 18 further includes a preferably continuous flange circumventing the central section.

The teething device 10 further includes a backing plate 16 and a face plate 14 capable of sandwiching a substantially planar image bearing object, such as a photograph 12, therebetween. The face plate 14 includes a member 17 that is constructed of a transparent acrylic or other transparent, non-toxic plastic material. The transparent nature of the face plate allows the infant to view the photograph 12 while protecting the photograph from the infant's saliva or from other physical damage. The photograph is interchangeable by a parent, etc., and preferably the teething device is used to house a photograph of a person recognizable to the infant to further visually stimulate the infant particularly during use as a teether.

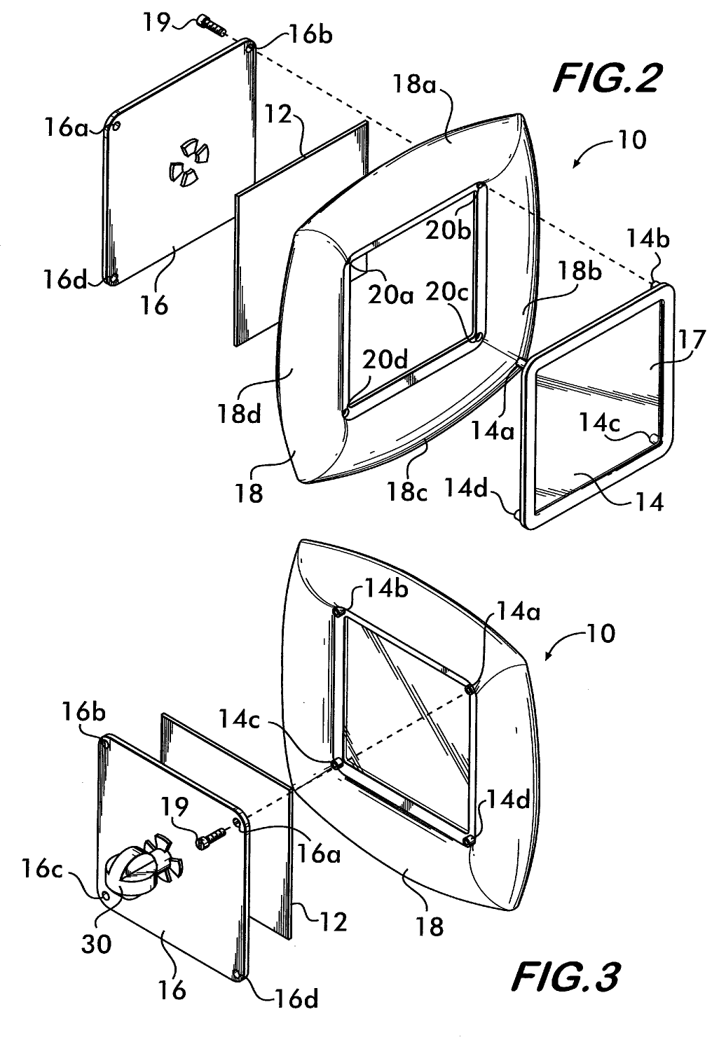

The backing plate 16, face plate 14 and teething ring 18 are configured to interlock with one another to enclose the image object 12. In the exemplary embodiment of FIGS. 1-3, face plate 14 is provided with screw-receiving bosses, 14a, 14b, 14c, 14d that project from a surface of the face plate 14 through apertures 20a, 20b, 20c, 20d of the teething ring 18. Corresponding apertures 16a, 16b, 16c, 16d are provided in the backing plate 16 through which screws are passed to secure the backing plate 16 to the teething ring, a team and face plate 14, and sandwich therebetween the photograph/image object 12. Thus, the face plate 14 and backing plate 16 are secured to the teething ring 18 by attaching the two plates to each other with screws as they sandwich and enclose the image object, as best shown in FIGS. 2 and 3. More specifically, in this embodiment, the flange, which is made of a rubbery material, is squeezed between the face plate 14 and backing plate 16 to form a liquid-resistant seal, and thus protect the enclosed image object/photograph 12 from deteriorative effects of saliva, etc. The screws may subsequently be removed to separate the plates and replace the image object 12 with a different image object.

Alternatively, the face plate 14 is connected to the backing plate 16 via other releasable connectors such as snaps, Velcroφ hook and loop fasteners, or the like. In highly preferred embodiments, the face plate 14 and backing plate 16 are attached to the teething ring 18 so as to create a seal to prevent in ingress of matter, such as saliva, that would be deteriorative to the photograph 12.

Preferably, the teething device 10 further includes a mounting member that may be used to repeatedly and releasably mount the teething device 10 to a stand capable of supporting the teething device in a substantially upright position, i.e. with the image object 12 in a substantially vertical position much like a conventional table standing picture frame. In the exemplary embodiment of FIGS. 1-3, the mounting member is provided on the backing plate 16, although the mounting member could be provided on the teething ring 18. In the embodiment of FIGS. 1-3, the mounting member is provided as a mounting lug 30 having an overall spherical shape for receipt in a corresponding socket of the stand to form a ball and socket type joint, as best shown in FIG. 3. The exemplary spherical mounting lug 30 shown in FIG. 3 is sectioned so that it may be injection molded as a unitary body in a relatively inexpensive and straightforward manner, as shown in FIG. 3.

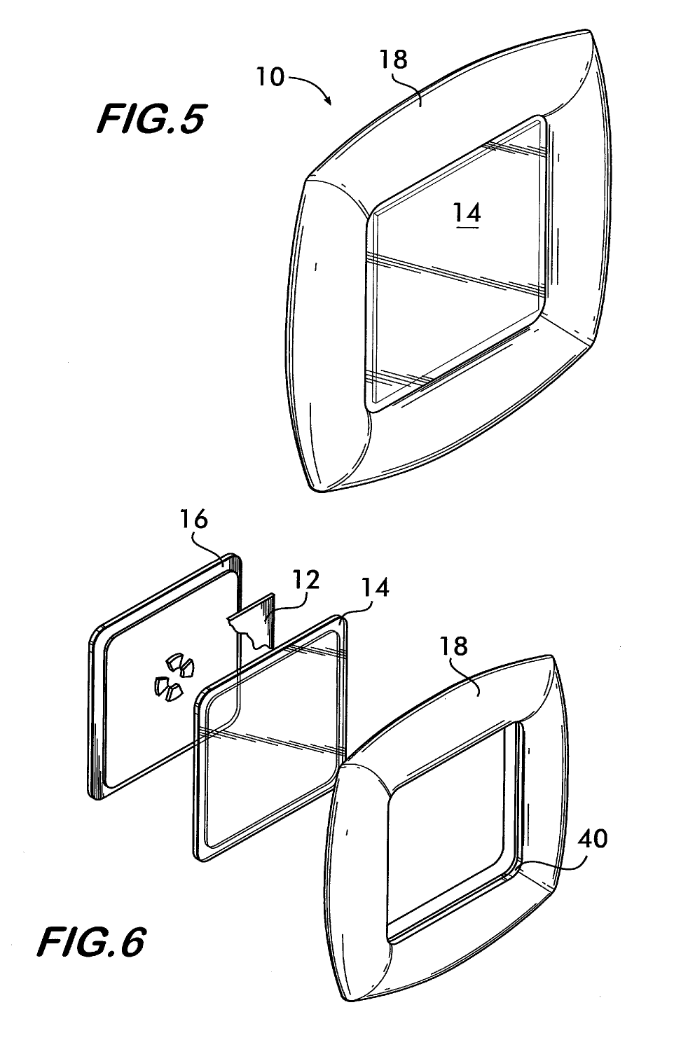

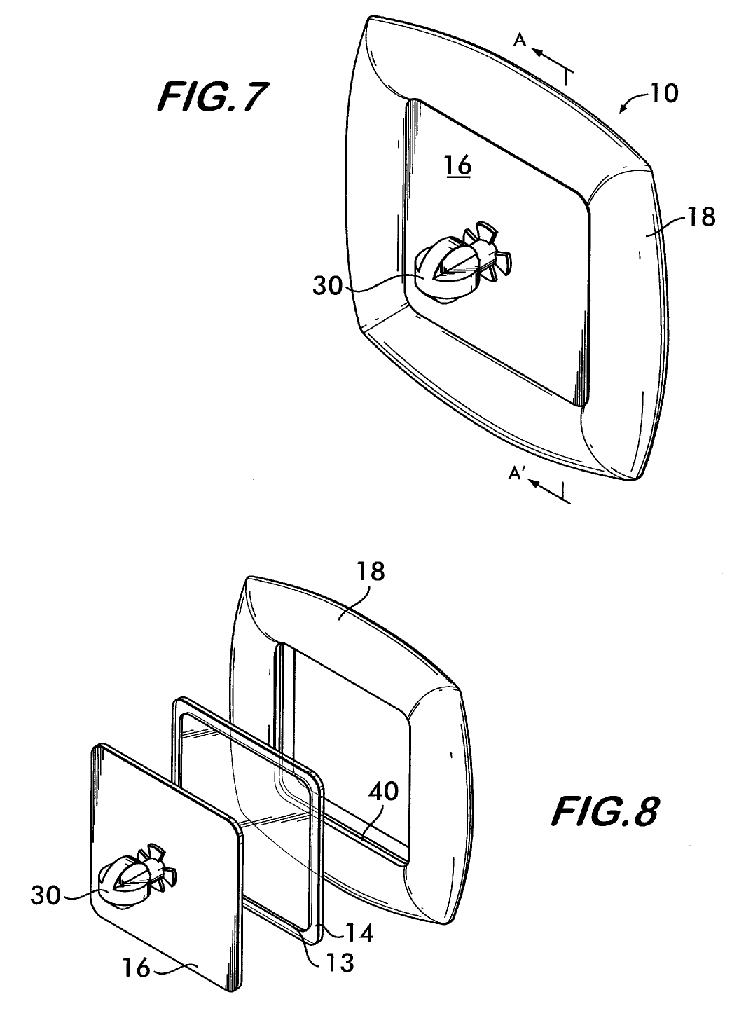

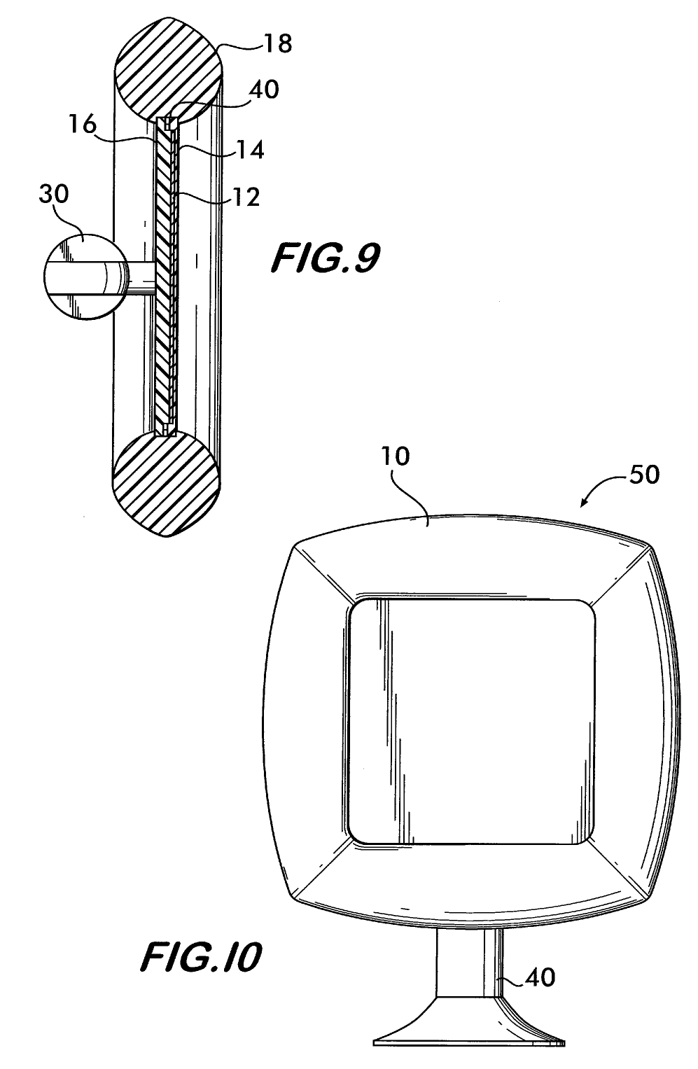

An alternative embodiment of the teething device 10 is shown in FIGS. 4-9, in which components corresponding to components of the exemplary embodiment of FIGS. 1-3 are labeled with corresponding reference numerals. Referring now to FIGS. 4-9, the teething device 10 includes a similar segmented teething ring 18, as best shown in FIGS. 4 and 5. The teething device 10 further includes a transparent face plate 14 and a backing plate 16 that can be interconnected with the teething ring 18, while sandwiching a photograph or other image object 12 therebetween.

Unlike the embodiment of FIGS. 1-3, no screws or other separate fasteners are required to interconnect the face plate 14, backing plate 16, and teething ring 18. Instead, the teething ring 18 is configured to define a groove 40 around its inside perimeter that is dimensioned to receive the face plate 14, the backing plate 16 and a substantially flat image object, such as a conventional photograph, as best shown in FIGS. 6, 8 and 9.

The material used to construct the teething ring 18 is selected to be sufficiently stretchable and/or resiliently deformable to allow the teething ring 18 to be stretched around the face plate 14 and backing plate 16 until they seat in the groove 40, at which point the teething ring 18 is permitted to resile to capture the face plate 14 and backing plate 16 in the groove 40.

Optionally, the face plate 14 and backing plate 16 may include complementary mounting fiducials to ensure positive engagement of the face plate 14 and backing plate 16 in proper alignment. In the exemplary embodiment shown in FIGS. 4-9, the face plate 14 includes a peripheral lip 13 extending beyond a planar surface of the face plate 14, as best shown in FIG. 8, and the backing plate 16 includes a peripheral recess 15 recessed below a planar surface of the backing plate 16, as best shown in FIG. 6. Various suitable alternative mounting fiducials may be employed, as will be appreciated by those skilled in the art. However, interfitting lip and recess fiducials that extend around the entire perimeter of the face plate 14 and backing plate 16, as shown in FIGS. 4-9, are preferred because of their ability to tightly enclose the image object and form a liquid-resistant seal protecting the image object from deteriorative effects of any saliva, etc. present during use of the teething device 10 as a teether.

As will be noted from FIGS. 6-9, this exemplary embodiment includes a spherical mounting lug 30, similar to that described above with reference to FIGS. 1-3, for mounting the teething device 10 to a stand for use to display the image object 12 in a manner similar to that of a conventional picture frame.

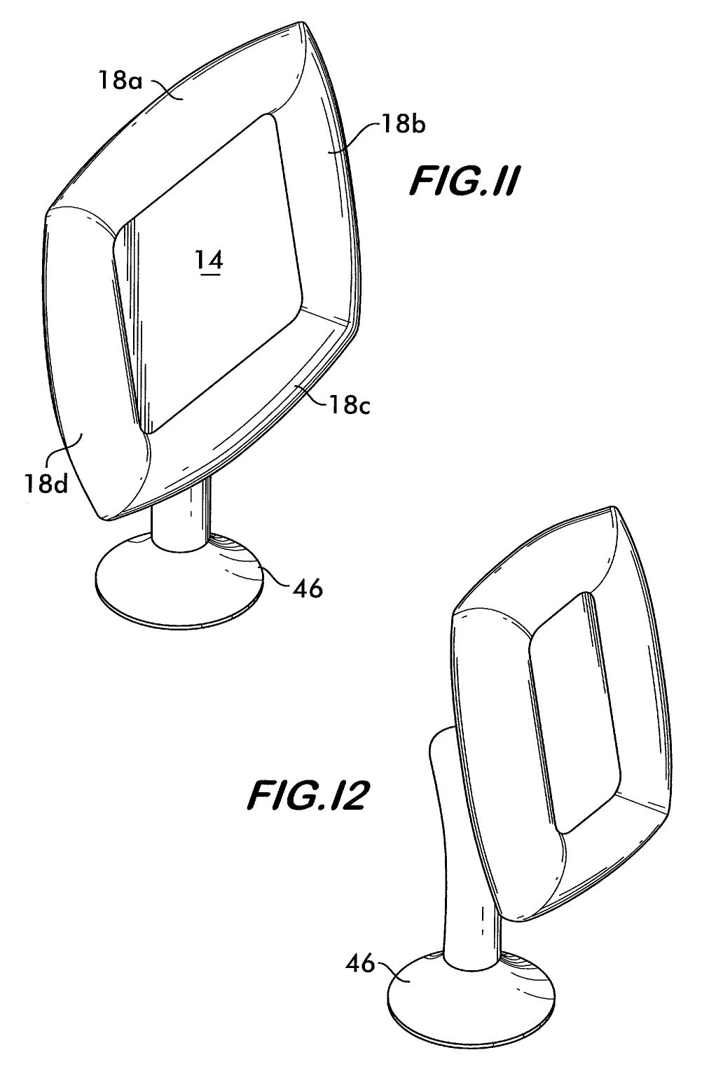

FIGS. 10-14 show the teething device 10 of FIGS. 4-9 mounted to a stand 40 for use to display the image object, 12 in a manner similar to that of a conventional picture frame. As shown in FIGS. 10-14, a picture frame 50 in accordance with the present invention includes a teething device 10, e.g. the teething device 10 of either FIGS. 1-3 or FIGS. 4-9, and a stand 40.

Referring now to FIGS. 10-14, the stand 40 includes an upright support member 42 and a base 46. The base 46 has a cross-sectional area greater than that of the upright member, to promote stability in mounting the stand 40 on a flat surface such as a table, highchair tray, etc. In one embodiment, the base 46 is rigid, e.g. a hard plastic, member, that will stand securely on a flat surface. In an alternative embodiment, the base 46 is a supple member, e.g. a soft plastic or rubber member, capable of functioning as a suction cup to secure the stand 40 to a flat surface, such as a table or highchair tray.

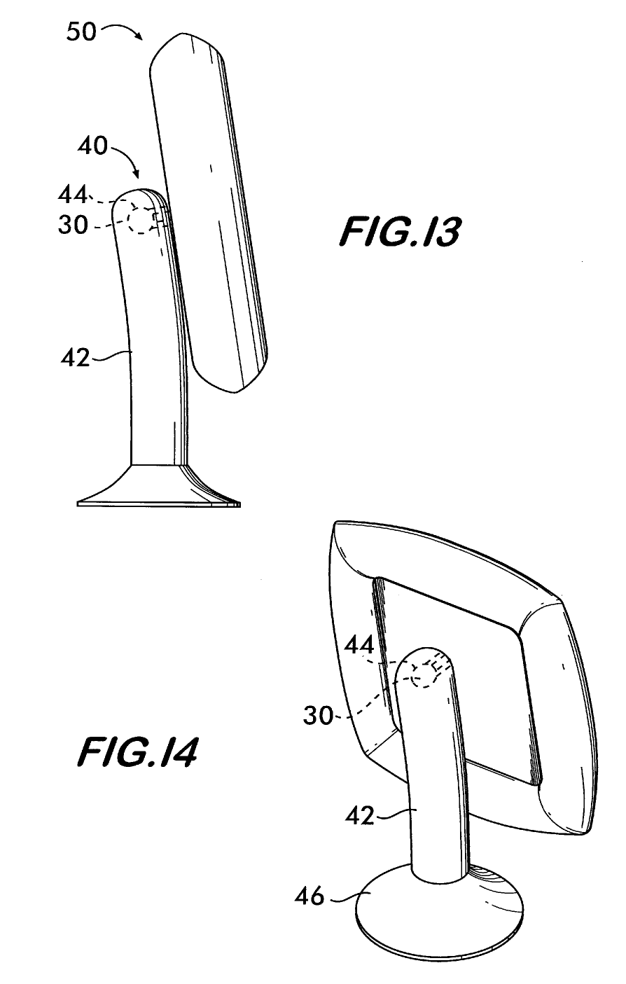

As best shown in FIGS. 13 and 14, the upright support member 42 defines toward its upper end opposite the base 46 a socket 44 capable of releasably receiving the mounting lug 30 of the teething device 10. In the exemplary embodiments shown, the socket 44 is preferably dimensioned to releasably receive the spherical mounting lug 30 of the teething device 10 in a manner permitting the mounting lug 30 to be snapped into the socket 44 and snapped out of the socket 44 with a moderate amount of manual force easily applied by an adult human. The socket 44 may be dimensioned as a partial sphere for this purpose. In other words, the mounting lug 30 and socket 44 and dimensioned for an interference fit to form a ball and socket joint. The ball and socket type joint allows for pivoting of the teething device 10 relative to the stand 50 to allow for positioning of the image object within an infant's field of view; thus providing visual stimulation.

Optionally, the upright support member 42 includes a gooseneck or other flexible, selectively positionable portion so that the socket 44 may be adjustably positioned relative to the base 46.

For example, this allows a parent to keep the teething device 10 mounted on the stand 40 to display the image object/photograph 12 as in a picture frame 50, and to subsequently remove the teething device 10 when desired to permit an infant child to hold the teething device 10 and use it as a teether to visually and physically stimulate the child, and to promote tooth/mouth development.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A teething device comprising:
a teething ring formed as a closed loop defining a central section, said teething ring being constructed of a rubbery material;
a transparent face plate dimensioned to be received within the central section;
a backing plate dimensioned to be received within the central section;
at least one of said face plate and said backing plate being releasably securable to the teething ring to define a space therebetween for receiving a substantially planar image-bearing object.

2. The teething device of claim 1, wherein said teething ring comprises a plurality of apertures spaced around said central section, and wherein at least one of said face plate and said backing plate comprises a plurality of bosses positioned in a corresponding spaced relationship for receipt in said plurality of apertures.

3. The teething device of claim 1, wherein said teething ring comprises a flange circumscribing said central section, and wherein said face plate is securable directly to said backing plate with said flange captured therebetween to form a liquid-resistant seal.

4. The teething device of claim 1, wherein said teething ring comprises a flange circumscribing said central section, and wherein said face plate is positioned on a first side of said flange, and said backing plate is positioned on an opposite side of said flange, said flange being compressed between said face plate and said backing plate to form a liquid-resistant seal.

5. The teething device of claim 1, further comprising:
a mounting lug supported in a predetermined position relative to said teething ring.

6. The teething device of claim 5, wherein said mounting lug is formed on said backing plate.

7. The teething device of claim 5, wherein said mounting lug is substantially spherical in shape.

8. The teething device of claim 1, wherein said teething ring comprises a plurality of visually discrete segments.

9. The teething device of claim 1, wherein each of said plurality of visually discrete segments is a respective one of a plurality of different colors.

10. A teething device comprising:
a teething ring formed as a closed loop defining a central section, said teething ring having an inner perimeter circumscribing said central section, said teething ring defining a groove extending along said inner perimeter
a transparent face plate dimensioned to be received within the groove; and
a backing plate dimensioned to be received within the groove;
said teething ring being constructed of a manually stretchable material and being dimensioned to require stretching of said teething ring to releasably position at least one of said face plate and said backing plate within said groove.

11. The teething device of claim 10, further comprising:
a mounting lug supported in a predetermined position relative to said teething ring.

12. The teething device of claim 11, wherein said mounting lug is formed on said backing plate.

13. The teething device of claim 12, wherein said mounting lug is substantially spherical in shape.

14. The teething device of claim 10, wherein said teething ring comprises a plurality of visually discrete segments.

15. The teething device of claim 10, wherein each of said plurality of visually discrete segments is a respective one of a plurality of different colors.

16. The teething device of claim 10, wherein each of said face plate and said backing plate comprise a respective one of a lip and a recess complementary to said lip, each of said lip and said recess extending around a perimeter of a respective one of said face plate and said backing plate.

17. A picture frame comprising:
a teething device of claim 5; and
a stand, said stand comprising:
a base configured to rest stably on a substantially flat surface; and
an upright support member joined to said base, said upright support member defining a socket dimensioned to releasably receive said mounting lug of said teething device.

18. The picture frame of claim 17, wherein said base further comprises a suction cup for fastening said stand to the substantially flat surface.

19. A picture frame comprising:
a teething device of claim 11; and
a stand, said stand comprising:
a base configured to rest stably on a substantially flat surface; and
an upright support member joined to said base, said upright support member defining a socket dimensioned to releasably receive said mounting lug of said teething device.

20. The picture frame of claim 19, wherein said base further comprises a suction cup for fastening said stand to the substantially flat surface.
